(19) United States
(12) Patent Application Publication
(10) Pub. No.: US 2009/0003556 A1
(43) Pub. Date: Jan. 1, 2009

(54) Method And Apparatus For Management Of Electronic Greetings Using A Telecommunication Service

(75) Inventors: John MATHEW, New York, NY (US); Vishal Patel, New Brunswick, NJ (US); Nirav Kadakia, Edison, NJ (US); Adam Tistler, Ridgewood, NJ (US)

Correspondence Address: MOSER IP LAW GROUP / VONAGE HOLDINGS CORP ., 1030 BROAD STREET, 2ND FLOOR, SHREWSBURY, NJ, 07702, US

(73) Assignee: Vonage Holdings Corporation, Holmdel, NJ (US)

(21) Appl. No.: 12/054,055

(22) Filed: Mar. 24, 2008

Related U.S. Application Data
(60) Provisional application No. 60/919,562, filed on Mar. 22, 2007.

(51) Int. Cl. H04M 1/64

(52) U.S. Cl. 379/88.23

(57) ABSTRACT

Method, apparatus, and computer readable medium for managing an electronic greeting in a telecommunication system are described. In some examples, a call from a subscriber is received via the telecommunication system. Descriptions of pre-recorded electronic content are played in the call. A selection of one or more items of the pre-recorded electronic content is received. An electronic greeting template is formed from the one or more items of the pre-recorded electronic content. The electronic greeting template is sent towards the subscriber via the telecommunication system, where the subscriber may then further manage the electronic greeting template as desired.

### CROSS-REFERENCE TO RELATED APPLICATIONS

This application claims priority to U.S. Provisional Patent Application Ser. No. 60/919,562, filed Mar. 22, 2007, which is incorporated by reference herein in its entirety.

### BACKGROUND OF THE INVENTION

1. Field of the Invention

The present invention relates generally to telecommunication systems and, more particularly, to a method and apparatus for management of electronic greetings using a telecommunication service.

2. Description of the Related Art

Historically, third party messaging services have been used in a number of applications, such as pre-recorded “wake up” calls for hotel guests, severe weather alerts for residents of a town or particular, affected geographic location, and pre-recorded advertising or introductory statements used by telemarketing companies. However, these communication tools or services have had limited success for a variety of reasons. One particular drawback is the necessity for those desiring the service (i.e., a hotel) to have to pay for expensive, dedicated equipment for the specific messaging purpose. The costs usually involve a large upfront cost for installation and components along with a periodic fee such as a monthly or annual service contract. If such a messaging system is installed on-site of the party desiring to provide the service, there are additional ancillary costs for tying the service into existing telephone lines, switches, and the like, power to operate the new components, loss of space for other business-related purposes, and required inspections for building code adherence and the like.

Voice over IP (VoIP) is a recent technological development in the field of telecommunications that is utilized to transmit voice conversations over a data network using the Internet Protocol (IP). Entities (either businesses or individuals) use VoIP by purchasing and installing a minimal amount of equipment (a Customer Premise Equipment (CPE) device) to access a VoIP service provider and subscribing to this telecommunication service. After the VoIP service has been subscribed to, and depending on the level of service requested, an entity can make phone calls to other VoIP subscribers or to public switched telephone network (PSTN) customers and access a number of features associated with the VoIP service such as an Instant Messaging Service, an address book feature and the like. However, there has been no advancement in exploiting the benefits of VoIP as a third party messaging service provider.

Therefore, there is a need in the art for managing electronic greetings using an IP-based telecommunications service.

### SUMMARY OF THE INVENTION

Method, apparatus, and computer readable medium for managing an electronic greeting in a telecommunication system are described. In some embodiments, a call from a subscriber is received via the telecommunication system. Descriptions of pre-recorded electronic content are played in the call. A selection of one or more items of the pre-recorded electronic content is received. An electronic greeting template is formed from the one or more items of the pre-recorded electronic content. The electronic greeting template is sent towards the subscriber via the telecommunication system, where the subscriber may then further manage the electronic greeting template as desired.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an exemplary embodiment of a communication system in accordance with one or more aspects of the invention;

FIG. 2 is a flow diagram depicting an exemplary embodiment of a method for managing electronic greetings using a telecommunications service in accordance with one or more aspects of the invention;

FIG. 3 is a block diagram depicting an exemplary embodiment of the electronic greeting server in accordance with one or more aspects of the invention; and

FIGS. 4 and 5 show a flow diagram depicting another exemplary embodiment of a method of managing electronic greetings using a telecommunications service in accordance with one or more aspects of the invention.

### DETAILED DESCRIPTION

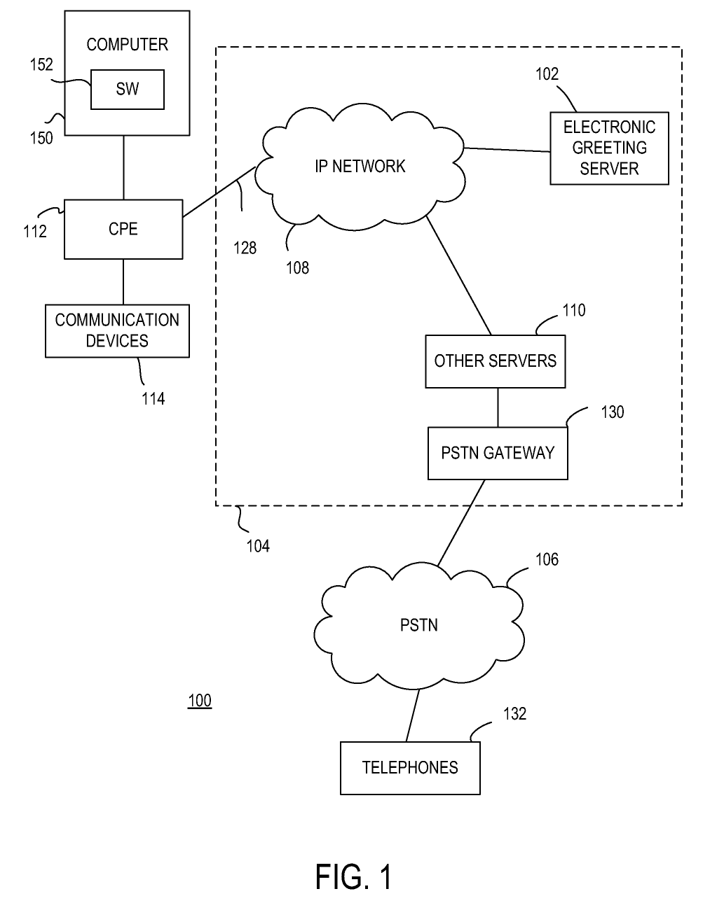

FIG. 1 is a block diagram depicting an exemplary embodiment of a communication system 100 in accordance with one or more aspects of the invention. The communication system 100 includes a voice-over-internet-protocol (VOIP) network 104 and a public switched telephone network (PSTN) 106. The VOIP network 104 includes an electronic greeting server 102 and a plurality of other servers 110 coupled to an internet protocol (IP) network 108. The servers 110 may be various well known servers configured to facilitate VOIP services, such as provisioning servers, proxy servers, media relay servers, and the like. The electronic greeting server 102 is configured to provide an electronic greeting service to subscribers, as described below. The servers 102 and 110 may be implemented using a plurality of computer systems and like type general and/or specific purpose devices and systems. The one or more of the servers 110 may be coupled to a PSTN gateway 130, which in turn is coupled to the PSTN 106. The PSTN 106 provides conventional telephone service to a plurality of telephones 132.

Various customer premises equipment (CPE) 112 are coupled to the IP network 108 via links 128. Various communication devices 114 may be coupled to the CPE 112. The CPE 112 may include modems, terminal adapters, routers, and the like configured to provide an interface between the communication devices 114 and the IP network 108. The communication devices 114 may comprise telephones, video phones, computers, mobile devices, and the like. Notably, the CPE 112 may be coupled to a computer 150. The computer 150 may include software 152, include operating systems, Internet software (e.g., e-mail client), and the like. The CPE 112 and the communication devices 114 may be distributed among a plurality of subscribers to VOIP services provided by the VOIP network 104. The links 128 may include cable, digital subscriber line (DSL), or like type communication links known in the art.

In general operation, subscribers use the communication devices 114 and the CPE 112 to convert content (e.g., voice, video, data, some or all of which may be analog) and signaling into VOIP-based content and signaling (“a VOIP call”). VOIP calls may be transmitted to the IP network 108 via the CPE 112 over the links 128. Those skilled in the art will appreciate that the VOIP calls may pass through other IP networks before reaching the IP network 108 of the VOIP network 104. For example, the VOIP calls may pass through various IP networks of the Internet before being routed to the IP network 108 (e.g., internet service provider (ISP) networks, backbone networks, etc.). VOIP calls may be processed by the servers 110. VOIP calls may be directed to other subscribers of the VOIP network 104, to subscribers of other VOIP networks (not shown), or to subscribers of traditional telephone services (e.g., the PSTN 106).

Some aspects of the invention relate to managing electronic greetings using an IP-based telecommunication service. Generally, when a subscriber activates their service (i.e., a VoIP service), they have access to a number of features, such as but not limited to call features like call waiting, call forwarding, do not disturb, caller ID, and the like. Additionally, the subscriber may have access to other IP-based services, such as instant messaging, email, and the like. Tying services and features together adds to the flexibility and pervasiveness of the services in general so that their adoption becomes increasingly widespread. In some embodiments, the VOIP network 104 provides a service (“electronic greeting service”) for managing electronic greetings so that subscribers may create and personalize such electronic greetings to produce an electronic greetings template (“template”). The VOIP network 104 may then deliver the template to the subscriber for the subscriber's use. In one embodiment, the template is delivered via electronic mail (e-mail). Once obtained, the template may be used at the subscriber's discretion to deliver personalized electronic greetings. The electronic greeting service may be facilitated by the electronic greeting server 102. For clarity, only a single electronic greeting server 102 is shown. Those skilled in the art will appreciate that the VOIP network 104 may include more than one electronic greeting server 102.

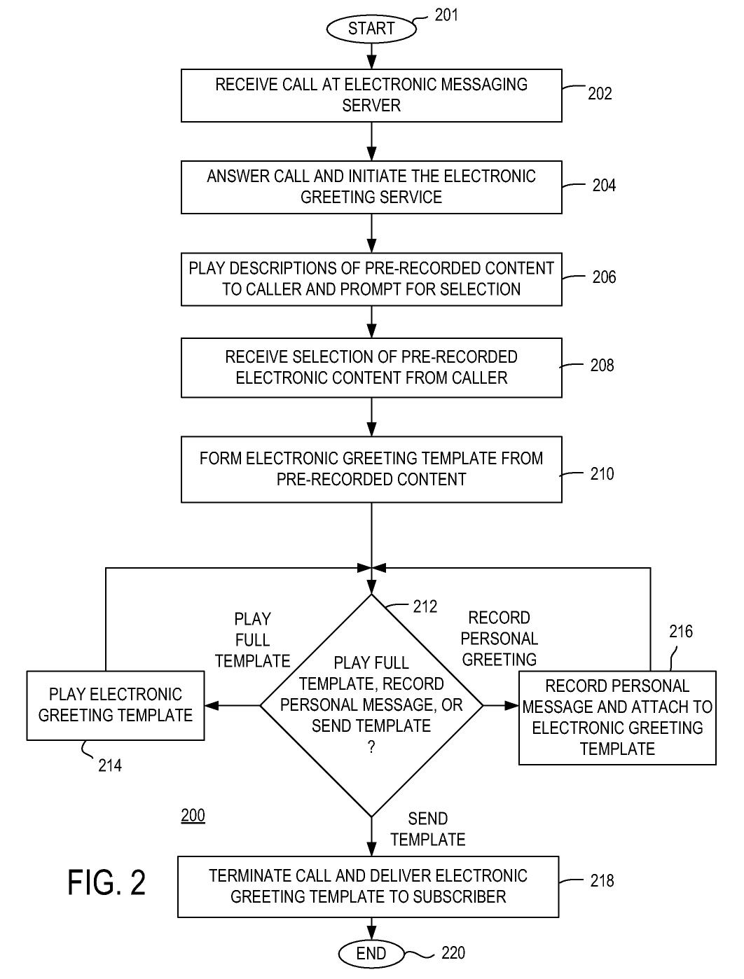

FIG. 2 is a flow diagram depicting an exemplary embodiment of a method 200 for managing electronic greetings using a telecommunications service in accordance with one or more aspects of the invention. Aspects of the method 200 may be described with respect to an electronic messaging service provided by the VOIP network 104. The method 200 begins at step 201 and proceeds to step 202, where a call is received by the electronic greeting server 102. The received call may be initiated by a subscriber using a communication device 114 and CPE 112. For example, subscribers may call a pre-defined telephone number, where the VOIP network 104 routes calls to that number to the electronic greeting server 102. Notably, the terms “subscriber” and “caller” are used interchangeably herein.

At step 204, the electronic greeting server 102 answers the call and initiates the electronic greeting service. For example, the electronic greeting server 102 may play an introductory greeting to the caller that describes the service. Notably, the VOIP network 104 may provide a plurality of different types of electronic greeting services. In some embodiments, each type of electronic greeting service may be associated with a different telephone number and with a different electronic greeting server. In some embodiments, a particular telephone number may be associated with a plurality of different types of electronic greetings and the electronic greeting server 102 may be used to manage such types.

At step 206, the electronic greeting server 102 may play descriptions of pre-recorded content to the caller and prompt the caller for a selection. For example, the electronic greeting server 102 may employ an interactive voice response (IVR) or other type of menu system. The menu system may present the different types of electronic greeting services available (if multiple types are handled by the electronic greeting server 102). The menu system may also present descriptions of different items of pre-recorded content that may be used to form an electronic greeting. The pre-recorded content may comprise audio content and/or video content.

For example, the pre-recorded content may be based on a Christmas holiday message involving a greeting from Santa initiated by dialing a theme based telephone number (e.g., 700-CALLSANTA). One skilled in the art can easily provide any number of alternate pre-programmed greetings for the caller to select from, including but not limited to those based on traditional, observed holidays and themes such as Santa Claus/Christmas, Kwanza, General Seasons Greetings, Happy New Year (Western or Chinese observed), St. Patrick's Day, Easter, Mothers Day, Fathers Day, Grandparents Day, Memorial Day, Independence Day, Labor Day, Halloween, or Thanksgiving. Such greetings may be selectable at the originally dialed number (accessing a first electronic greeting server) or by dialing alternate holiday-oriented telephone numbers (accessing a second or more electronic greeting servers or different menus/access points of the first electronic greeting server). In other examples, the greeting content may be of a more personal, non-holiday specific event including but not limited to engagements, weddings, anniversaries, birthdays, religious celebrations, and the like. In other examples, the greeting content may contain education/historical content relevant to a specific occurrence. Such educational/historic content may include but is not limited to the story of the birth of Christ (on or about the Christmas holiday), Hindu religion at a glance (on or about the Hindu New Year and/or other annual ceremonies), stories about the Presidents of the United States (on or about Presidents Day), explanation of the Big Bang Theory (on or about Earth Day and/or astronomical events such as eclipses, comets, meteor showers and the like). Those skilled in the art will appreciate that the pre-recorded content may a myriad of content items in addition to those above.

As is known in the art, the caller may make selections on the menu system via voice response or by sending dual tone multi-frequency (DTMF) tones from their communication device. The menu system may allow the caller to select multiple items of electronic content and may provide a selection that allows the caller to indicate that no more selections are desired (i.e., exit the menu system).

At step 208, the electronic greeting server 102 receives the caller's selection of pre-recorded content. The caller may select one or more items of pre-recorded content. If multiple items are selected, the caller may select the sequence of such items. For example, the sequence may be defined based on the order the caller selected the items. At step 210, the electronic greeting server 102 forms an electronic greeting template from the selected electronic content. The electronic greeting template includes the selected items of electronic content and may include one or more additional items, such as introductory greetings, descriptions of the greeting service, and the like.

At step 212, the electronic greeting server 102 provides a menu allowing the caller to play the full electronic greeting template, record a personal message, or send the greeting template to him/herself. The menu may be an IVR or other type of menu system and the caller may respond using voice or DTMF tones. If the caller chooses to play the electronic greeting template, the method 200 proceeds to step 214, where the electronic greeting server 102 plays back the electronic greeting template as currently formed. This allows the caller to verify the electronic greeting template is as desired. The method 200 returns to step 212.

If the caller chooses to record a personal message, the method 200 proceeds to step 216. At step 216, the electronic greeting server 102 prompts the caller to record a message, records the message, and attaches the message to the electronic greeting template. The message may be attached before, after, or within the item(s) pre-recorded content. The position of personal message may be selected by the user via a menu provided by the electronic greeting server 102 or may be a default position selected by the electronic greeting server 102. The method 200 returns to step 212. If the caller chooses to send the electronic greeting template, the method 200 proceeds to step 218. At step 218, the electronic greeting server 102 terminates the call and delivers the electronic greeting template to the subscriber. The method 200 then concludes at step 220.

In some embodiments, the electronic greeting template is sent to the subscriber via e-mail. The electronic greeting template may include the pre-recorded electronic content selected by the subscriber, as well as the subscriber's customized message if generated. The pre-recorded electronic content and customized message (if generated) can be implemented using any type of audio or audio/video format known in the art, such as the WAV format, MP3 format, AIFF format, or like type audio formats, as well as WMA, MPEG, and like type video formats. The e-mail may include a pre-formed text template having the audio and/or video file(s). In some embodiments, the electronic greeting server 102 may perform a lookup function of the subscriber's account information in order to obtain the subscriber's e-mail address for delivery of the template. Other account information for the subscriber may also be added to the lookup function to further personalize the template, including but not limited to the subscriber's geographic location. In other embodiments, the electronic greeting server 102 may prompt the subscriber for his/her e-mail address using an IVR menu or the like during step 218 before the call is terminated. Although e-mail is described above as an exemplary delivery method, it is to be understood that other methods may be employed. For example, delivery of the electronic greeting template may be performed via e-mail or alternative delivery methods including but not limited to Short Messaging Services (SMS).

The caller may receive the electronic greeting template via email at the computer 150. Upon delivery, the caller may see an introductory greeting announcing the personal electronic greeting template (e.g., introductory text in an e-mail). Such personalized electronic greeting template may then be played if desired (e.g., items of audio and/or video content may be played). The personalized electronic greeting template delivered to the subscriber may act as a template for the subscriber to use to generate specific electronic greetings that may optionally be further managed (e.g., created, sent) to the caller's personal contacts and/or third parties. In one embodiment, this part of the management process may be accomplished by generating one or more new emails which include the previously delivered personalized electronic greeting template, and delivering the one or more new emails to the caller's personal contacts and/or third parties.

In some embodiments, Session Initiation Protocol (SIP) is used to establish the subscriber call to the electronic greeting server 102 to order the greeting. SIP was developed by the Internet Engineering Task Force (IETF) and published in 2002 as RFC 3261, which is herein incorporated by reference. Those skilled in the art will appreciate that other protocols may be used to establish calls in a VOIP network. In some embodiments, Real-time Transfer Protocol (RTP) is used to record personal messages of the subscriber (if any) and to deliver the electronic greeting to the recipient(s). RTP defines a standardized packet format for delivering audio and video over the Internet and was developed by the Audio-Video Transport Working Group of the IETF and first published in 1996 as RFC 1889, which was made obsolete in 2003 by RFC 3550, both of which are herein incorporated by reference. Those skilled in the art will appreciate that other protocols may be used to record the personal messages and for the delivery of the electronic greeting to the recipient(s).

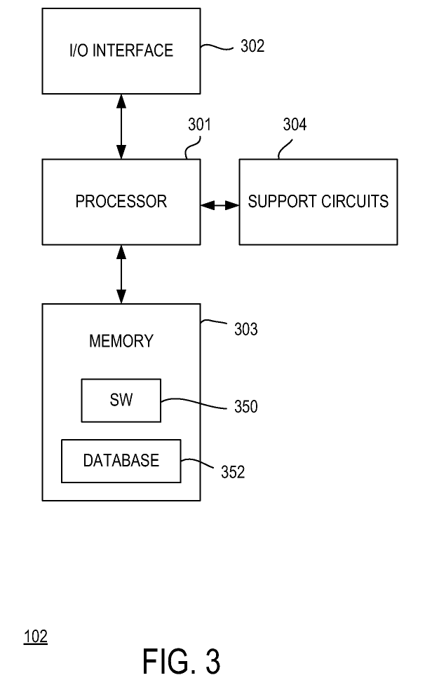

FIG. 3 is a block diagram depicting an exemplary embodiment of the electronic greeting server 102 in accordance with one or more aspects of the invention. The server 102 may be one of any form of a general purpose computer used in accessing and operating within an IP-based network. The electronic greeting server 102 may include a processor 301, a memory 303, various support circuits 304, and an I/O interface 302. The processor 301 may include one or more microprocessors or the like known in the art. The support circuits 304 include conventional cache, power supplies, clock circuits, data registers, and the like. The I/O interface 302 is configured for communication with the IP network 108. The memory 303, or computer readable medium, may include one or more of the following random access memory, read only memory, magneto-resistive read/write memory, optical read/write memory, cache memory, magnetic read/write memory, and the like.

The memory 303 may store software 350 that is executed to perform methods of managing electronic greetings, as described herein. The memory 303 may also store a database 352 of pre-recorded electronic content. The software 350, when executed by the processor 301, transforms the general purpose computer into a specific purpose computer that controls the automated electronic greeting management process. As such, the process rapidly and easily identifies the telecommunication service and CPE device status and executes a management function as required. Although embodiments of the process of the present invention are discussed as being implemented as a software routine, some of the method steps that are disclosed herein may be performed in hardware or a combination of hardware and software. As such, the invention may be implemented in software as executed upon a computer system, in hardware as an application specific integrated circuit or other type of hardware implementation, or a combination of software and hardware.

Additionally, the software 350 may be used to automatically manage one or more additional services that the telecommunications service provider offers, such as an instant messaging (IM) service, an email service, or a combination of these services or other services known to those skilled in the art of telecommunications. Further, the software 350 may act as a “stand alone” program or may be embedded with one or more other routines or programs that provide one or more additional telecommunication services. The software 350 of the present invention is capable of being executed on computer operating systems including but not limited to Microsoft Windows 98, Microsoft Windows XP, Apple OS X and Linux. Similarly, the software 350 of the present invention is capable of being performed using CPU architectures including but not limited to Apple Power PC, AMD/Intel x86, Sun SPARC, and Intel ARM.

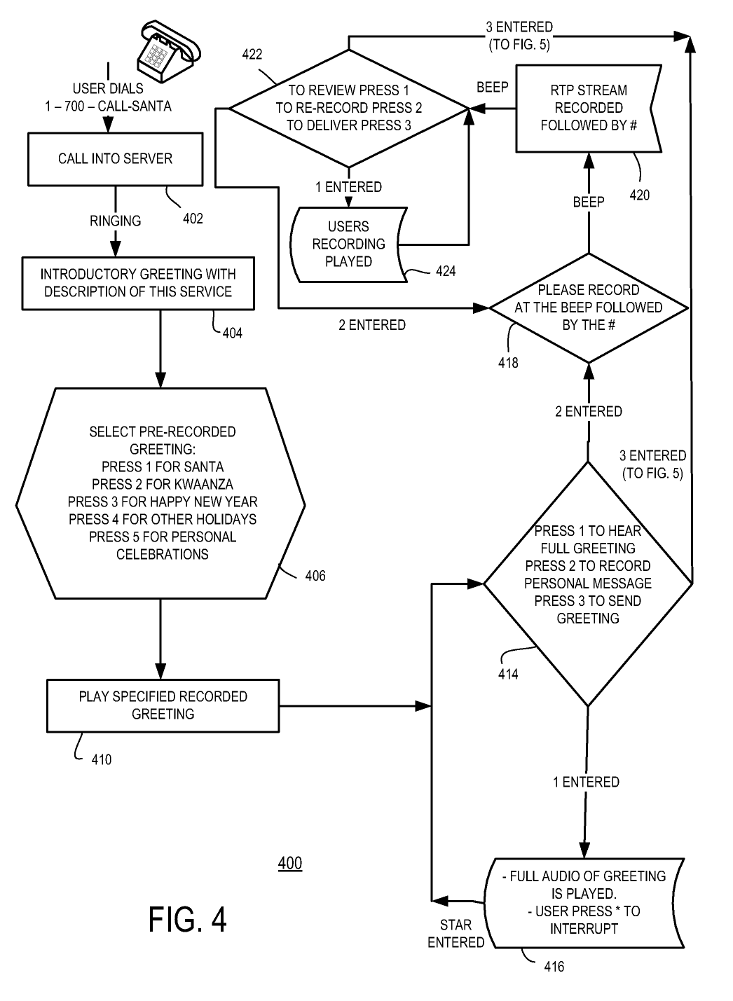

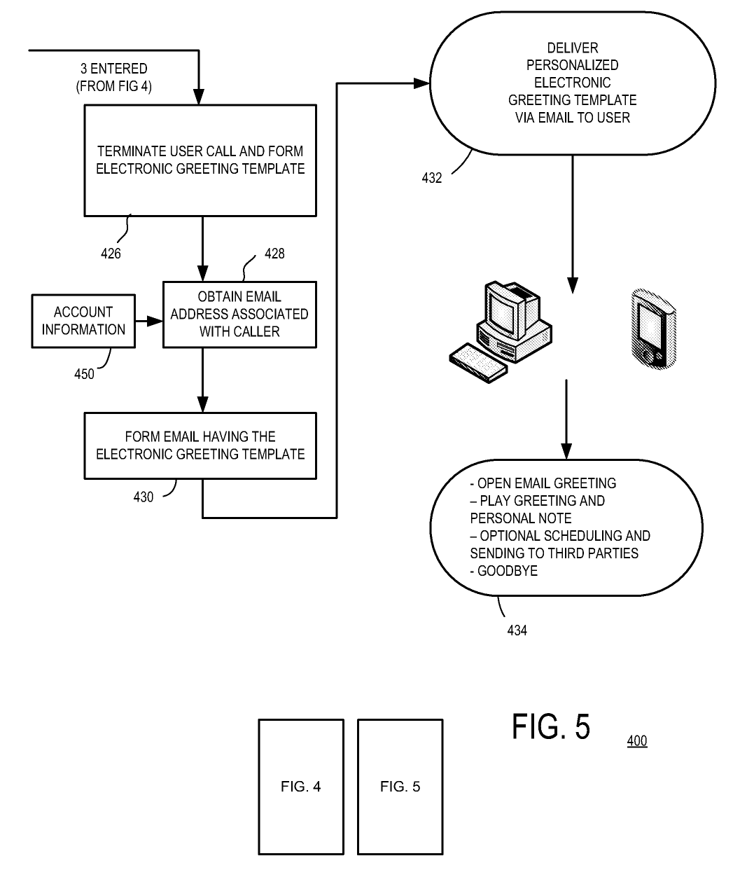

FIGS. 4 and 5 show a flow diagram depicting another exemplary embodiment of a method 400 of managing electronic greetings using a telecommunications service in accordance with one or more aspects of the invention. The method 400 illustrates one of a myriad of possible electronic greeting services that may be provided by the present invention. The method 400 begins at step 402, where a caller dials a telephone number associated with the electronic greeting service, for example, 1-700-CALL-SANTA. The VOIP network 104 routes the call to the electronic greeting server 102.

At step 404, the electronic greeting server 102 answers the call and plays an introductory greeting with a description of the greeting service provided. The electronic greeting server 102 then plays descriptions of pre-recorded content. For example, the electronic greeting server 102 may provide the following menu system: “Press 1 for Santa; Press 2 for Kwanza; Press 3 for Happy New Year; Press 4 for other holidays; Press 5 for personal celebration.” At step 406, the caller is prompted to make a selection. The method 400 may repeat the selection options offered at step 406 if no response is received, or if a response not applicable to any of the selection options is received. For any valid selection by the caller, the method 400 proceeds to step 410.

At step 410, the electronic greeting server 102 plays the selected pre-recorded content. The method then proceeds to step 414. At step 414, the electronic greeting server 102 provides a menu allowing the caller to play the full electronic greeting of the pre-recorded content, record a personal message, or send the greeting to him/herself. If the caller chooses to play the electronic greeting, the method 400 proceeds to step 416, where the electronic greeting is played back to the caller. The caller may interrupt the playback by pressing a key, such as the star (*) key. The method returns to step 414 from step 416.

If the caller chooses to record a personal message, the method 400 proceeds to step 418. At step 418, the electronic greeting server 102 prompts the caller to record a personal message after an indicator (e.g., a beep) followed by a termination key, such as the pound (#) key. The caller records a personal message at step 420 and presses the termination key. At step 422, the electronic greeting server 102 provides a menu allowing the caller to review the personal message, re-record the personal message, or send the electronic greeting. If the caller chooses to review the message, the method 400 proceeds to step 424, where the personal message is played back to the caller. The method proceeds from step 424 back to step 422. If the caller chooses to re-record the personal message, the method 400 proceeds to step 418 and repeats. If the caller chooses to send the message at step 422 or 414, the method 400 proceeds to step 426.

At step 426, the electronic greeting server 102 terminates the call and forms an electronic greeting template. The electronic greeting template comprises the pre-recorded content and the caller's personal message if a personal message was created. The method 400 then proceeds to step 428, where the electronic greeting server 102 obtains an email address associated with the caller. In some embodiments, the electronic greeting server 102 may obtain the email address automatically from account information 450 associated with the user. In other embodiments, the electronic greeting server 102 may obtain the email address during the call (e.g., using an IVR system). The method then proceeds to step 430.

At step 430, an email is formed having the electronic greeting template. The address field of the email is populated with the email address of the caller obtained at step 428. At step 432, the email having the electronic greeting template is delivered to the caller. The method 400 then proceeds to step 434, where the caller can open the email and play the electronic greeting template. The caller may optionally schedule and send the electronic greeting template to one or more third parties.

The benefits of using VoIP as a third party messaging service are apparent based on an understanding of VoIP infrastructure and processes. First, since VoIP is capable of operating on a packet-based (i.e., IP) network, there is no need to alter existing telephone equipment beyond that of the initial subscription and installation process. That is, the electronic greeting server 102 is preferably part of the VoIP provider equipment, thus, power, space and general economics of operating same are part of the subscriber's basic costs or recovered on a nominal per usage charge. Second, all maintenance and upkeep of the electronic greeting server 102 are invisible to the subscriber thus making use of this feature/service more user friendly and economical. While one basic application of third party messaging service is disclosed herein, it is submitted that additional applications similar to those offered in PSTN-type communications networks are possible by simply scaling the number of input operators and/or output greeting recipients based on the specific purpose for the greeting/message.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method of managing an electronic greeting in a telecommunication system, comprising:
receiving a call via the telecommunication system from a subscriber;
playing descriptions of pre-recorded electronic content in the call;
receiving a selection of one or more items of the pre-recorded electronic content; and
forming an electronic greeting template from the one or more items of the pre-recorded electronic content,

2. The method of claim 1, wherein the telecommunications system includes an internet protocol (IP) communication network, and wherein the call is made using a voice-over-internet protocol (VOIP) service over the IP communication network.

3. The method of claim 1, further comprising:
receiving a request to play the electronic greeting template during the call;
playing the electronic greeting template in the call in response to the request.

4. The method of claim 1, further comprising:
receiving a request to include a personal message with the electronic greeting template;
recording electronic content comprising the personal message during the call; and
attaching the personal message to the electronic greeting template.

5. The method of claim 1, further comprising:
sending the electronic greeting template towards the subscriber.

6. The method of claim 5, wherein the step of sending comprises:
obtaining an email address associated with the subscriber;
delivering the electronic greeting template to the subscriber in an email addressed to the email address.

7. The method of claim 6, wherein the email address is obtained automatically from account information of the subscriber or directly from the subscriber using dual tone multi-frequency (DTMF) commands.

8. The method of claim 1, wherein the descriptions are played as part of a menu system, and wherein the selections of the one or more items of electronic content comprise voice or dual tone multi-frequency (DTMF) commands.

9. Apparatus for managing an electronic greeting in a telecommunication system, comprising:
a database configured to store pre-recorded electronic content; and
a server, coupled to the telecommunication system, configured to:
receive a call via the telecommunication system from a subscriber;
play descriptions of at least a portion of the pre-recorded electronic content in the call;
receive a selection of one or more items of the pre-recorded electronic content;
form an electronic greeting template from the one or more items of the pre-recorded electronic content; and
send the electronic greeting template towards the subscriber.

10. The apparatus of claim 9, wherein the telecommunications system includes an internet protocol (IP) communication network, and wherein the call is made using a voice-over-internet protocol (VOIP) service over the IP communication network.

11. The apparatus of claim 9, wherein the server is further configured to:
receive a request to play the electronic greeting template during the call;
play the electronic greeting template in the call in response to the request.

12. The apparatus of claim 9, wherein the server is further configured to:
receive a request to include a personal message with the electronic greeting template;
record electronic content comprising the personal message during the call; and
attach the personal message to the electronic greeting template.

13. The apparatus of claim 9, wherein the server is further configured to:
obtain an email address associated with the subscriber;
deliver the electronic greeting template to the subscriber in an email addressed to the email address.

14. The apparatus of claim 13, wherein the server is configured to obtain the email address automatically from account information of the subscriber or directly from the subscriber using dual tone multi-frequency (DTMF) commands.

15. The apparatus of claim 10, wherein the descriptions are played as part of a menu system, and wherein the selections of the one or more items of electronic content comprise voice or dual tone multi-frequency (DTMF) commands.

16. A computer readable medium having instructions stored thereon that, when executed by a processor, cause the processor to perform a method of managing an electronic greeting in a telecommunication system, comprising:
receiving a call via the telecommunication system from a subscriber;
playing descriptions of pre-recorded electronic content in the call;
receiving a selection of one or more items of the pre-recorded electronic content;
forming an electronic greeting template from the one or more items of the pre-recorded electronic content; and
sending the electronic greeting template towards the subscriber.

17. The computer readable medium of claim 16, wherein the telecommunications system includes an internet protocol (IP) communication network, and wherein the call is made using a voice-over-internet protocol (VOIP) service over the IP communication network.

18. The computer readable medium of claim 16, further comprising:
receiving a request to play the electronic greeting template during the call;
playing the electronic greeting template in the call in response to the request.

19. The computer readable medium of claim 16, further comprising:
receiving a request to include a personal message with the electronic greeting template;
recording electronic content comprising the personal message during the call; and
attaching the personal message to the electronic greeting template.

20. The computer readable medium of claim 16, wherein the step of sending comprises:
obtaining an email address associated with the subscriber;
delivering the electronic greeting template to the subscriber in an email addressed to the email address.

21. The computer readable medium of claim 16, wherein the descriptions are played as part of a menu system, and wherein the selections of the one or more items of electronic content comprise voice or dual tone multi-frequency (DTMF) commands.
